(19) United States
(12) Patent Application Publication
(10) Pub. No.: US 2025/0158104 A1
(43) Pub. Date: May 15, 2025

(54) BATTERY BOX

(71) Applicant: INDUSTRIAL TECHNOLOGY RESEARCH INSTITUTE, Hsinchu (TW)

(72) Inventor: Sheng-Fa YEH, Miaoli City (TW)

(73) Assignee: INDUSTRIAL TECHNOLOGY RESEARCH INSTITUTE, Hsinchu (TW)

(21) Appl. No.: 18/535,678

(22) Filed: Dec. 11, 2023

(30) Foreign Application Priority Data
Nov. 15, 2023 (TW) 112143986

(51) Int. Cl. H01M 10/04; H01M 50/204; H01M 50/242; H01M 50/264

(52) U.S. Cl. CPC H01M 10/0481; H01M 50/204; H01M 50/242; H01M 50/264

(57) ABSTRACT

A battery box configured to accommodate a battery pack and including a housing, at least one pushing assembly and a cylinder. The housing is configured to accommodate the battery pack. The at least one pushing assembly includes a pushing plate and a pushed plate. The pushing plate is configured to be stacked on a side of the battery pack. The pushed plate is configured to be stacked on a side of the pushing plate that is located farthest away from the battery pack. The pushed plate includes a frame part and a plurality of rib parts. The plurality of rib parts are connected to the frame part and are surrounded by the frame part. The cylinder is disposed in the housing and configured to push the pushed plate.

### CROSS-REFERENCE TO RELATED APPLICATIONS

All related applications are incorporated by reference. The present application is based on, and claims priority from, Taiwan (International) Application Serial Number 112143986 filed on Nov. 15, 2023, the disclosure of which is hereby incorporated by reference herein in its entirety.

### TECHNICAL FIELD

The disclosure relates to a battery box.

### BACKGROUND

Due to the property of having high capacity, some manufactures replace the lithium-ion battery used as a power source of a vehicle, such as electric scooter or electric motorcycle, by the lithium-metal battery. In order to allow the lithium-metal battery to have good electrical characteristics, a stress or force should be applied to the lithium-metal battery when charging or discharging electricity therefrom, thereby allowing the lithium metal layer deposited on the surface of the anode to have fine and smooth surface.

### SUMMARY

One embodiment of this disclosure provides a battery box, configured to accommodate a battery pack, and including a housing, at least one pushing assembly and a cylinder. The housing is configured to accommodate the battery pack. The at least one pushing assembly includes a pushing plate and a pushed plate. The pushing plate is configured to be stacked on one side of the battery pack. The pushed plate is configured to be stacked on one side of the pushing plate that is located farthest away from the battery pack. The pushed plate includes a frame part and a plurality of rib parts. The plurality of rib parts are connected to the frame part and are surrounded by the frame part. The cylinder is disposed in the housing and configured to push the pushed plate.

Another embodiment of this disclosure provides a battery box configured to accommodate a battery pack. The battery pack includes a plurality of battery cells stacked along a stacking direction. The battery box includes a housing, at least one cylinder and at least one transmission assembly. The at least one cylinder includes a cylinder body and a movable rod. The cylinder body is disposed in the housing. The movable rod is movably disposed at the cylinder body along a moving direction. The at least one transmission assembly is configured to connect the movable rod of the at least one cylinder and the battery pack. The movable rod is configured to apply a driving force to the at least one transmission assembly to make the movable rod pushing the battery pack via the at least one transmission assembly. The moving direction is non-parallel to the stacking direction.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective exploded view of a battery module according to a first embodiment of the disclosure;

FIG. 2 is a side cross-sectional view of the battery module in FIG. 1;

FIG. 3 is a perspective view of the battery module in FIG. 1 omitting a housing and a circuit board assembly;

FIG. 4 is an exploded view of the battery module in FIG. 1 omitting the housing and the circuit board assembly;

FIG. 5 is a perspective exploded view of a battery module according to a second embodiment of the disclosure;

FIG. 6 is a side cross-sectional view of the battery module in FIG. 5;

FIG. 7 is a perspective view of the battery module in FIG. 5 omitting a housing and a circuit board assembly;

FIG. 8 is a perspective exploded view of a battery module according to a third embodiment of the disclosure;

FIG. 9 is a perspective exploded view of the battery module in FIG. 8 omitting a housing and a circuit board assembly; and

FIG. 10 is a side cross-sectional view of a battery module according to a fourth embodiment of the disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

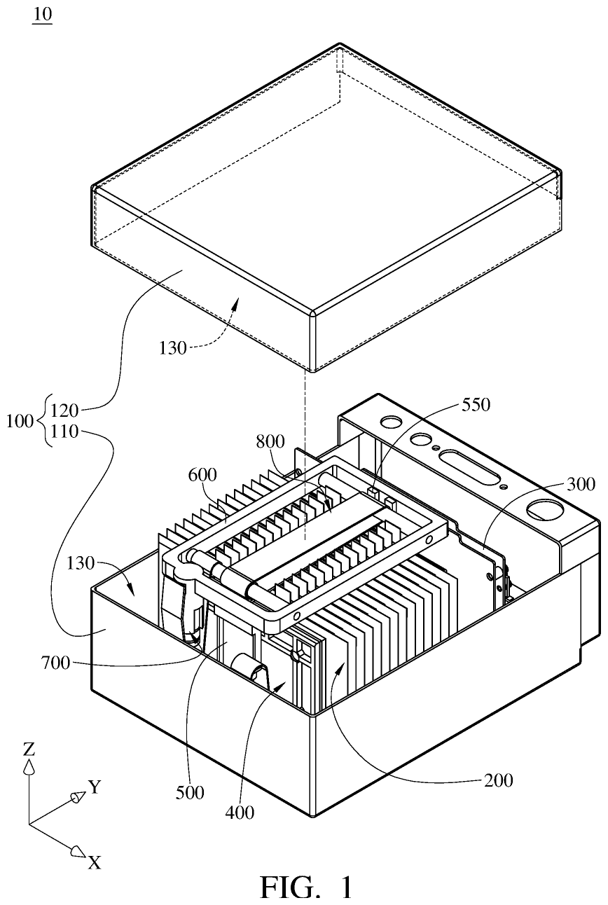

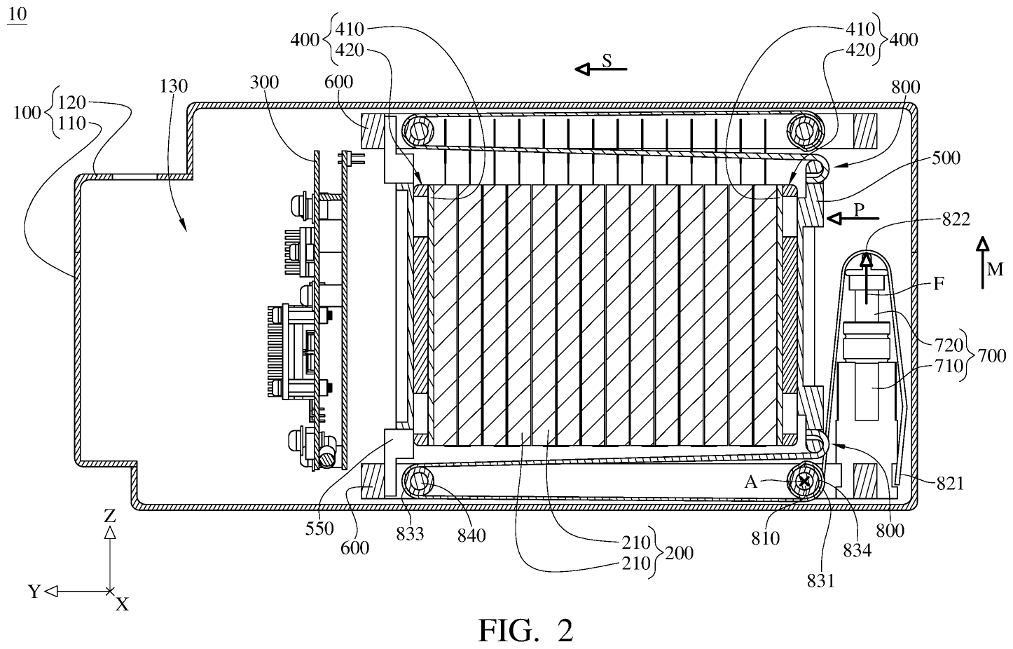

Please refer to FIGS. 1 and 2. FIG. 1 is a perspective exploded view of a battery module 10 according to a first embodiment of the disclosure. FIG. 2 is a side cross-sectional view of the battery module 10 in FIG. 1.

In this embodiment, the battery module 10 is, for example, a lithium-metal battery module. The battery module 10 includes a housing 100, a battery pack 200, a circuit board assembly 300, two pushing assemblies 400, two connecting plates 500 and 550, two mounting frames 600, two cylinders 700 and two transmission assemblies 800. The housing 100, the two pushing assemblies 400, the two connecting plates 500 and 550, the two mounting frames 600, the two cylinders 700 and the two transmission assemblies 800 may together configure a battery box. The said battery box is configured to accommodate the battery pack 200 and configures the battery module 10 together with the battery pack 200.

In this embodiment, the housing 100 may include a first housing part 110 and a second housing part 120. The first housing part 110 is stacked on a side of the second housing part 120, and the first housing part 110 and the second housing part 120 together form an accommodation space 130 therebetween. The disclosure is not limited by the configuration of the housing 100. In other embodiments, the housing may be formed as a single body instead of including two housing parts that are stacked on each other.

The battery pack 200 includes a plurality of battery cells 210. The battery cells 210 may be stacked along a stacking direction S and disposed in the accommodation space 130 of the housing 100. The circuit board assembly 300 is, for example, a Battery Management System (BMS). The circuit board assembly 300 is disposed in the accommodation space 130 of the housing 100, and is electrically connected to the battery cells 210.

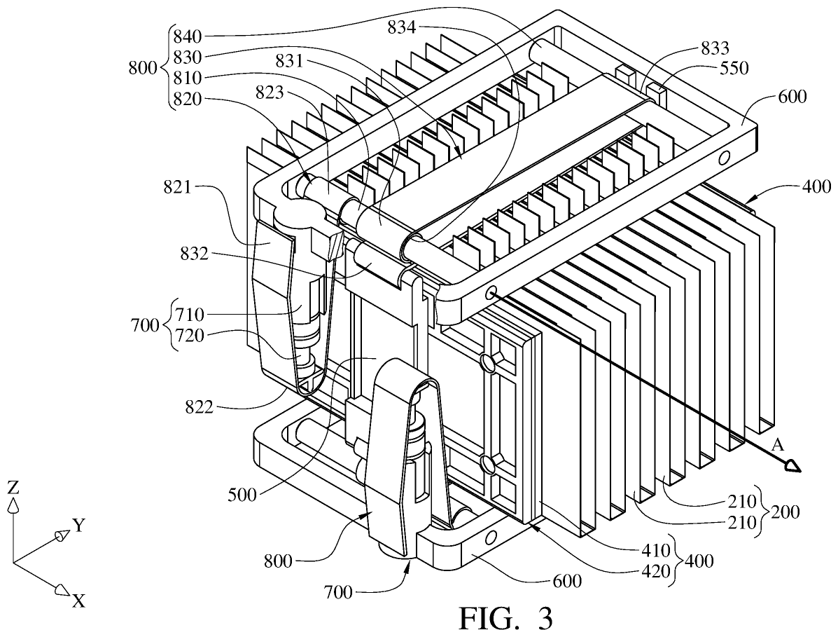

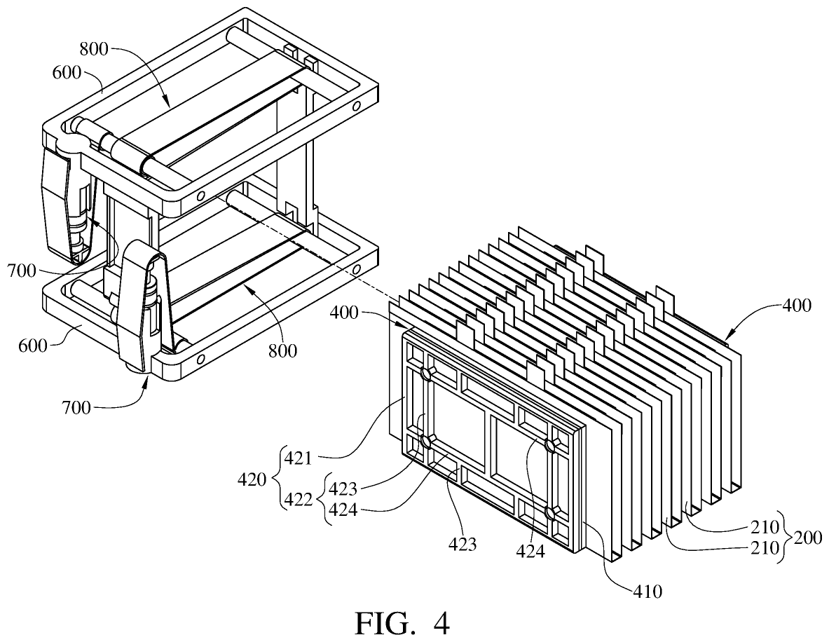

Please refer to FIGS. 2 to 4. FIG. 3 is a perspective view of the battery module 10 in FIG. 1 omitting the housing 100 and the circuit board assembly 300. FIG. 4 is an exploded view of the battery module 10 in FIG. 1 omitting the housing 100 and the circuit board assembly 300.

The two pushing assemblies 400 are similar in structure. Thus, one of the two pushing assemblies 400 will be described in detail hereinafter. The pushing assembly 400 includes a pushing plate 410 and a pushed plate 420. The pushing plate 410 is stacked on one side of the battery pack 200. The pushed plate 420 is stacked on one side of the pushing plate 410 that is located farthest away from the battery pack 200. In this embodiment, the pushed plate 420 includes a frame part 421 and a plurality of rib parts 422. The rib parts 422 are connected to the frame part 421, and are surrounded by the frame part 421. Each rib part 422 may have a square cross-section. In this embodiment, the pushed plate 420 is fixed to the pushing plate 410 by, for example, adhering, but the disclosure is not limited thereto. In other embodiments, the pushed plate and the pushing plate may be integrally formed as a single piece. In addition, in other embodiments, the cross section of each rib part may be in a circular shape or any other shapes that allowing the stress or force to be uniformly transferred from the pushed plate to the pushing plate.

Moreover, as shown in FIG. 4, the rib parts 422 include a plurality of first rib parts 423 and a plurality of second rib parts 424. The first rib parts 423 and the second rib parts 424 are connected to one another. Also, the first rib parts 423 are perpendicular to the second rib parts 424. That is, an extension direction of each first rib part 423 is perpendicular to an extension direction of each second rib part 424. The first rib parts 423 and the second rib parts 424 are connected to the frame part 421, and are surrounded by the frame part 421. In other embodiments, the rib parts may include one first rib part and one second rib part so that the first rib part and the second rib part are together in a cross shape.

Furthermore, as shown in FIG. 2, the two pushing plates 410 of the two pushing assemblies 400 are stacked on two opposite sides of the battery pack 200, respectively. The two connecting plates 500 and 550 rest on sides of the two pushed plates 420 that are located farthest away from the pushing plate 410, respectively.

The two mounting frames 600 are located in the accommodation space 130 of the housing 100. The two mounting frames 600 are spaced apart from each other, and are fixed to the housing 100. The connecting plate 550 rests on the two mounting frames 600.

The two cylinders 700 and the two transmission assemblies 800 are disposed on the two mounting frames 600, respectively. Also, the two cylinders 700 are configured to pull the two connecting plates 500 and 550 via the two transmission assemblies 800, respectively. Thus, the two connecting plates 500 and 550 are configured to force the two pushing assemblies 400 to push the battery pack 200, respectively. Hereinafter, the detail structure and the connection relationship of a pair of the cylinder 700 and transmission assembly 800 that are corresponding to each other will be mainly described for brevity.

The cylinder 700 is, for example, a pneumatic cylinder. The cylinder 700 includes a cylinder body 710 and a movable rod 720. The cylinder body 710 is fixed to the mounting frame 600 and disposed in the housing 100. The movable rod 720 is movably disposed at the cylinder body 710 along a moving direction M. In this embodiment, the moving direction M is non-parallel to the stacking direction S of the battery cells 210. Further, the moving direction M is, for example, perpendicular to the stacking direction S of the battery cells 210. The disclosure is not limited by the type of the cylinder 700. In other embodiments, the cylinder may be a hydraulic cylinder.

Since the moving direction M is non-parallel to the stacking direction S of the battery cells 210, less space is occupied by the cylinder 700 along the stacking direction S. In this way, more battery cells 210 are allowed to be disposed in the accommodation space 130 of the housing 100, thereby increasing the total capacity of the battery module 10; alternatively, the volume of the battery box may be reduced without decreasing the number of the battery cells 210, thereby improving the flexibility for using the battery box.

In addition, in this embodiment, the two cylinders 700 are, for example, misaligned with each other. Thus, the space utilization of the accommodation space 130 of the housing 100 is improved.

In this embodiment, the transmission assemblies 800 includes a first roller 810, a first transmission belt 820, a second transmission belt 830 and a second roller 840.

The first roller 810 is rotatably disposed on the mounting frames 600. The first transmission belt 820 connects the movable rod 720 and the first roller 810. Specifically, the first transmission belt 820 includes a fixed portion 821, a pushed portion 822 and a sleeve portion 823. The pushed portion 822 connects the fixed portion 821 and the sleeve portion 823. The fixed portion 821 is fixed to the housing 100. The sleeve portion 823 is sleeved or wound on the first roller 810. The pushed portion 822 is connected to the movable rod 720, and is configured to be pushed by the movable rod 720. An axial direction A of the first roller 810 is non-parallel to the moving direction M and the stacking direction S. Further, as shown in FIG. 2, the axial direction A, the stacking direction S and the moving direction M are parallel to X-axis direction, Y-axis direction and Z-axis direction, respectively. That is, the axial direction A is, for example, perpendicular to the moving direction M and the stacking direction S. Thus, the first roller 810 is configured to change the direction of the stress or force transferred from the movable rod 720.

The second transmission belt 830 is spaced apart from the first transmission belt 820 along the axial direction A of the first roller 810. The second transmission belt 830 includes a first fixed portion 831, a second fixed portion 832 and a wound portion 833. The wound portion 833 connects the first fixed portion 831 and the second fixed portion 832. The first fixed portion 831 is fixed to the first roller 810. As shown in FIG. 3, the second fixed portion 832 is fixed to the connecting plate 500. In FIG. 3, in order to clearly show the relationship between the second fixed portion 832 and the connecting plate 500, a part of the mounting frame 600 is omitted.

In this embodiment, the second transmission belt 830 further includes a pre-wound portion 834. The pre-wound portion 834 is connected to an end of the first fixed portion 831 that is located farthest away from the wound portion 833, and is wound on the first roller 810.

The second roller 840 is rotatably disposed on the mounting frames 600, and is spaced apart from the first roller 810. The wound portion 833 is sleeved or wound on the second roller 840, and the wound portion 833 and the second roller 840 configured a labor-saving structure similar to a movable pulley.

As shown in FIGS. 3 and 4, the two movable rods 720 of the two cylinders 700 are connected to the two first transmission belts 820 of the two transmission assemblies 800, respectively. The two second fixed portions 832 of the two second transmission belts 830 are fixed to two opposite sides of the connecting plate 500, respectively. Thus, the connecting plate 500 is allowed to push the pushed plate 420 in a uniform manner.

As shown in FIGS. 2 to 4, the cylinder body 710 is configured to drive the movable rod 720 to come out of the cylinder body 710 so that the movable rod 720 applies a driving force F to the pushed portion 822 of the first transmission belt 820. The pushed portion 822 forces the sleeve portion 823 to rotate the first roller 810. The rotation of the first roller 810 moves the first fixed portion 831 of the second transmission belt 830, and thus the first fixed portion 831 forces the second fixed portion 832 to pull the connecting plate 500 along a pushing direction P via the wound portion 833. Accordingly, the connecting plate 500 pushes the battery pack 200 via the pushing assembly 400 along the pushing direction P to apply a stress or force to the battery pack 200. When the battery pack 200 expands or contracts along the stacking direction S during the charge or discharge thereof, the force or stress applied from the cylinder body 710 to the movable rod 720 may be adjusted, so as to adjust the driving force F applied from the movable rod 720 to the pushed portion 822, thereby allowing a constant stress or force to be applied to the battery pack 200.

In the pushing assembly 400, the rib parts 422 having, for example, square cross-section are connected to the frame part 421 and surrounded by the frame part 421. Thus, the cylinder 700 is allowed to uniformly transfer the stress or the force to the battery pack 200 via the pushing assembly 400, thereby allowing the battery pack 200 to have good electrical characteristics.

In addition, the first fixed portion 831 moves the second fixed portion 832 via the wound portion 833 sleeved or wound on the second roller 840. Thus, the wound portion 833 pulls the connecting plate 500 along the pushing direction P by a labor-saving mechanism similar to that of the movable pulley. In this way, the number of the cylinders 700 is allowed to be decreased while providing the desired amount of stress or force applied to the battery pack 200, which reduces the space inside the housing 100 that is occupied by the cylinders 700 and reduces the overall weight of the battery module 10 or the battery box.

When the battery pack 200 expands along the stacking direction S, the pre-wound portion 834 is unwound from the first roller 810 to allow the second transmission belt 830 to be moved with the swelling of the battery pack 200.

The battery module 10 according to the disclosure is not limited to being the lithium-metal battery module. In other embodiments, the battery module may be any types of battery module whose battery pack is required to be pressed or pushed. In addition, in other embodiments, the battery module may include one pushing assembly, one cylinder and one transmission assembly.

Other embodiments are described below for illustrative purposes. The following embodiments use the reference numerals and a part of the contents of the above embodiments, the same reference numerals are used to denote the same or similar elements, and the description of the same technical contents is omitted. For the description of the omitted part, reference may be made to the above embodiments, and details are not described in the following embodiments.

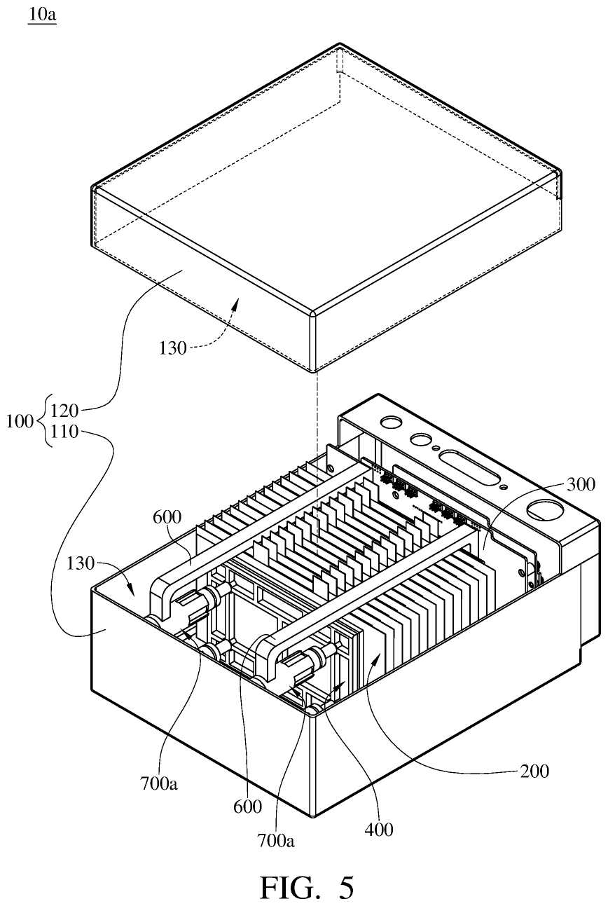

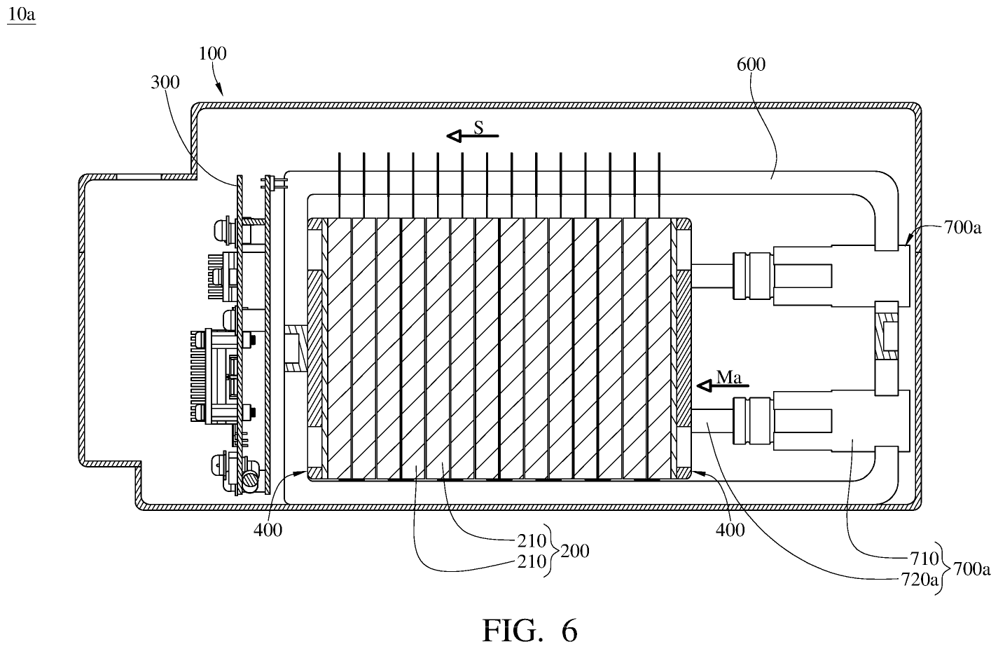

The disclosure is not limited by the relationship between the moving direction of the movable rod and the stacking direction of the battery cells. Please refer to FIGS. 5 and 6. FIG. 5 is a perspective exploded view of a battery module 10a according to a second embodiment of the disclosure. FIG. 6 is a side cross-sectional view of the battery module 10a in FIG. 5. The main difference between the battery module 10a of this embodiment and the battery module 10 of the first embodiment is the moving direction Ma of the movable rod 720a of the cylinders 700a. In this embodiment, the battery module 10a includes the housing 100, the battery pack 200, the circuit board assembly 300, the two pushing assemblies 400, the two mounting frames 600 and four cylinders 700a. The housing 100, the two pushing assemblies 400, the two mounting frames 600 and the four cylinders 700a may together configure a battery box. The said battery box is configured to accommodate the battery pack 200 and configures the battery module 10a together with the battery pack 200.

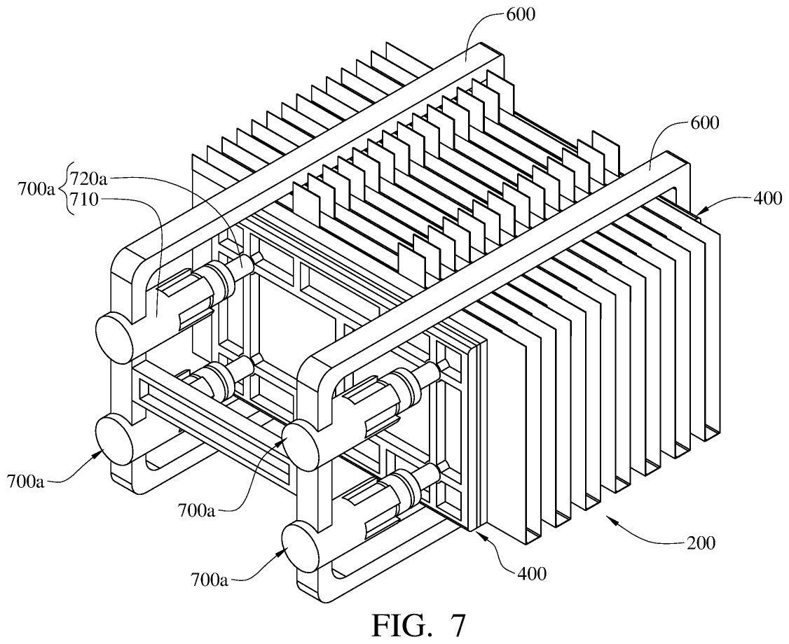

Please refer to FIGS. 6 and 7. FIG. 7 is a perspective view of the battery module 10a in FIG. 5 omitting the housing 100 and the circuit board assembly 300. In this embodiment, the moving direction Ma of the movable rod 720a of each cylinder 700a is parallel to the stacking direction S of the battery cells 210. Thus, in this embodiment, the movable rod 720a of each cylinder 700a is designed to be in direct contact with the pushed plate 420 of the pushing assembly 400. Therefore, comparing to the first embodiment, the battery module 10a is not required to include the connecting plates 500 and 550 and the transmission assemblies 800, thereby simplifying the structure of the battery module 10a and reducing the manufacture cost of the battery module 10a.

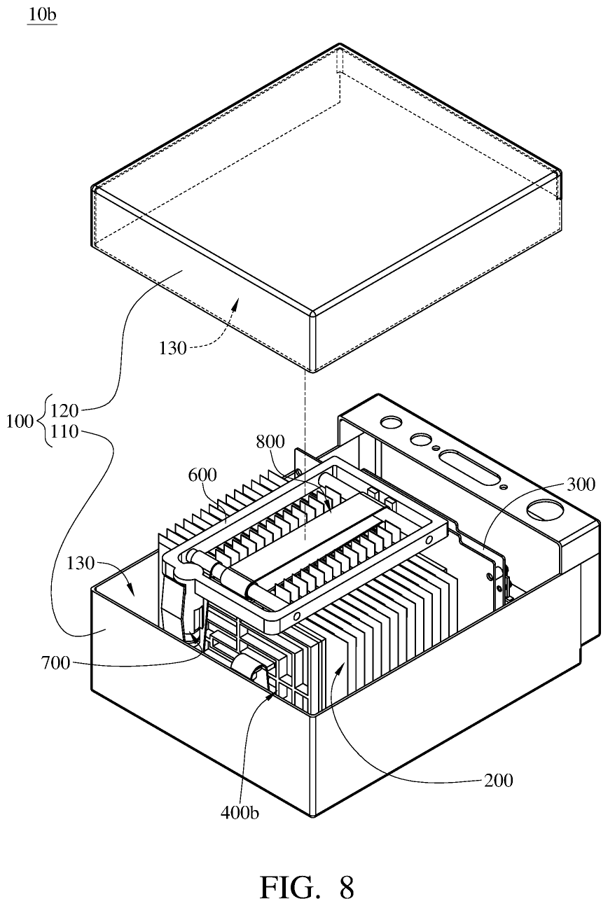

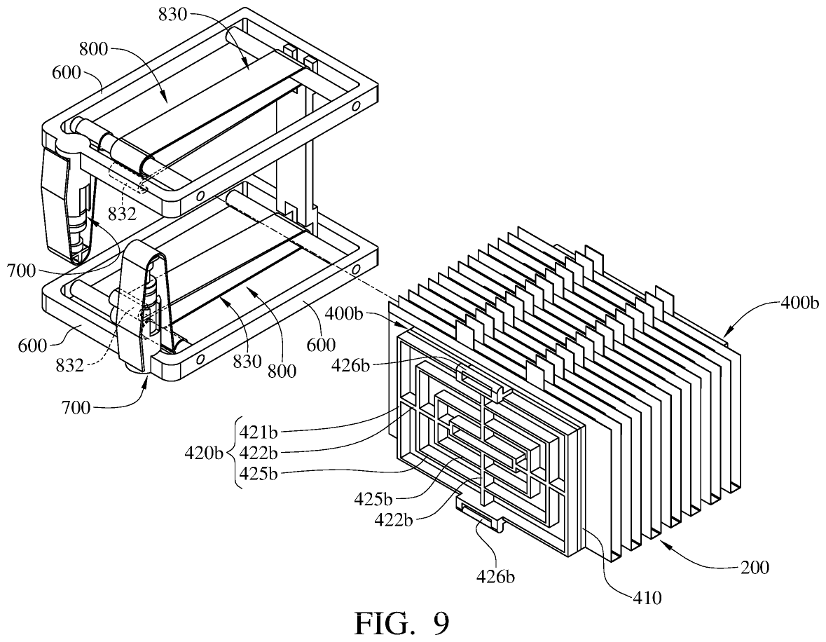

The disclosure is not limited by the structure of the pushed plate. Please refer to FIGS. 8 and 9. FIG. 8 is a perspective exploded view of a battery module 10b according to a third embodiment of the disclosure. FIG. 9 is a perspective exploded view of the battery module 10b in FIG. 8 omitting a housing 100 and a circuit board assembly 300. The main difference between the battery module 10b of this embodiment and the battery module 10 of the first embodiment is the structure of the pushed plate 420b of each pushing assembly 400b. In this embodiment, the pushed plate 420b includes a frame part 421b, a plurality of rib parts 422b and a plurality of peripheral rib parts 425b. The rib parts 422b and the peripheral rib parts 425b may have square cross sections. The rib parts 422b connect the peripheral rib parts 425b and the frame part 421b. The frame part 421b surrounds the rib parts 422b and the peripheral rib parts 425b. The peripheral rib parts 425b are spaced apart from one another. In addition, in this embodiment, the pushed plate 420b has two fixing protrusions 426b respectively on two opposite sides of the pushed plate 420b. The two second fixed portions 832 of the two second transmission belts 830 are fixed to the two fixing protrusions 426b, respectively. In other words, in this embodiment, the connecting plate 500 in the first embodiment used as the structure for fixing the second fixed portion 832 is replaced by the fixing protrusions 426b. The housing 100, the two pushing assemblies 400b, the two mounting frames 600, the two cylinders 700 and the two transmission assemblies 800 may together configure a battery box. The said battery box is configured to accommodate the battery pack 200 and configures the battery module 10b together with the battery pack 200.

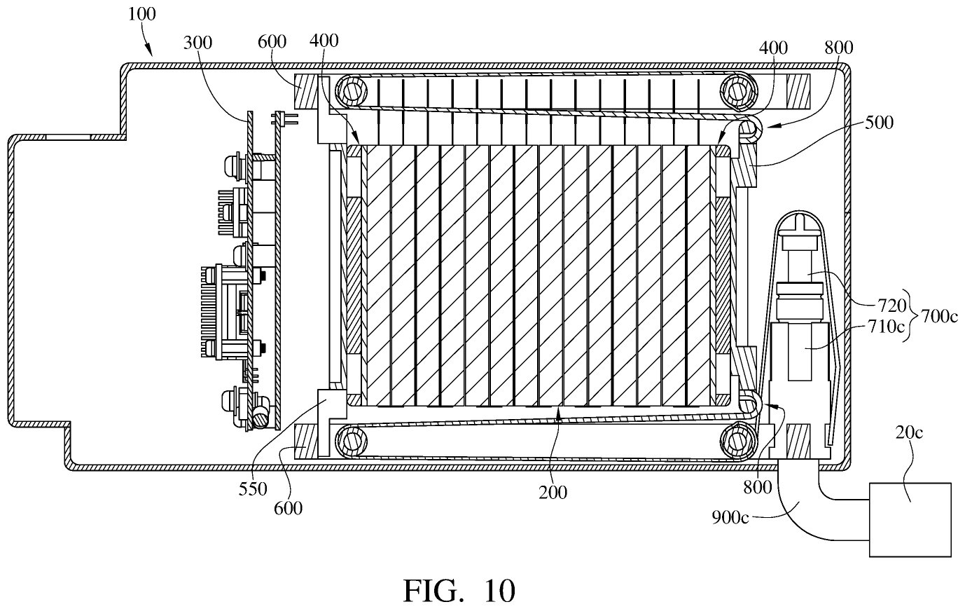

The disclosure is not limited by the way for the cylinders to produce a force or a stress. Please refer to FIG. 10. FIG. 10 is a side cross-sectional view of a battery module 10c according to a fourth embodiment of the disclosure. The main difference between the battery module 10c of this embodiment and the battery module 10 of the first embodiment is in that the cylinder body 710c of the cylinder 700c of this embodiment is in fluid communication with an external container 20c via a tube 900c. In this way, since the configuration of the external container 20c (e.g., such as the volume of the external container 20c) is not limited by the housing 100, the external container 20c is allowed to provide an operation fluid to the cylinder body 710c in a more flexible and stable manner. Thus, the cylinder 700c is allowed to produce a force or a stress in a more flexible and stable manner. Additionally, the battery module 10c includes the housing 100, the battery pack 200, the circuit board assembly 300, the two pushing assemblies 400, the two connecting plates 500 and 550, the two mounting frames 600, two cylinders 700c and the two transmission assemblies 800. The housing 100, the two pushing assemblies 400, the two connecting plates 500 and 550, the two mounting frames 600, the two cylinders 700c and the two transmission assemblies 800 may together configure a battery box. The said battery box is configured to accommodate the battery pack 200 and configures the battery module 10c together with the battery pack 200.

According to the battery box disclosed by above embodiments, in the pushing assembly, the rib parts having, for example, square cross-section is connected to the frame part and surrounded by the frame part. Thus, the cylinder is allowed to uniformly transfer the stress or the force to the battery pack via the pushing assembly, thereby allowing the battery pack to have good electrical characteristics. Alternatively, Since the moving direction of the movable rod is non-parallel to the stacking direction of the battery cells, less space is occupied by the cylinder along the stacking direction. In this way, more battery cells are allowed to be disposed in the housing.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A battery box, configured to accommodate a battery pack, comprising:
a housing, configured to accommodate the battery pack;
at least one pushing assembly, comprising a pushing plate and a pushed plate, wherein the pushing plate is configured to be stacked on one side of the battery pack, the pushed plate is configured to be stacked on one side of the pushing plate that is located farthest away from the battery pack, the pushed plate comprises a frame part and a plurality of rib parts, and the plurality of rib parts are connected to the frame part and are surrounded by the frame part; and
a cylinder, disposed in the housing and configured to push the pushed plate.

2. The battery box according to claim 1, wherein the plurality of rib parts of the pushed plate comprises a plurality of first rib parts and a plurality of second rib parts, the plurality of first rib parts are perpendicular and connected to the plurality of second rib parts, and the plurality of first rib parts and the plurality of second rib parts are connected to the frame part and surrounded by the frame part.

3. The battery box according to claim 1, wherein the pushed plate further comprises a plurality of peripheral rib parts, the plurality of peripheral rib parts are spaced apart from one another, the plurality of rib parts connect the plurality of peripheral rib parts and the frame part, and the frame part surrounds the plurality of peripheral rib parts and the plurality of rib parts.

4. The battery box according to claim 1, wherein the at least one pushing assembly comprise two pushing assemblies, the pushing plates of the two pushing assemblies are configured to be stacked on two opposite sides of the battery pack, respectively, and the cylinder is configured to push the pushed plate of one of the two pushing assemblies.

5. The battery box according to claim 1, wherein the plurality of rib parts have square cross sections.

6. A battery box, configured to accommodate a battery pack, the battery pack comprising a plurality of battery cells stacked along a stacking direction, the battery box comprising;
a housing;
at least one cylinder, comprising a cylinder body and a movable rod, wherein the cylinder body is disposed in the housing, and the movable rod is movably disposed at the cylinder body along a moving direction; and
at least one transmission assembly, configured to connect the movable rod of the at least one cylinder and the battery pack, wherein the movable rod is configured to apply a driving force to the at least one transmission assembly to make the movable rod pushing the battery pack via the at least one transmission assembly;
wherein, the moving direction is non-parallel to the stacking direction.

7. The battery box according to claim 6, further comprising a pushing assembly, wherein the pushing assembly is configured to be stacked on one side of the battery pack, the at least one transmission assembly comprises a first roller, a first transmission belt and a second transmission belt, the first roller is rotatably disposed on the housing, the first transmission belt connects the movable rod and the first roller, an axial direction of the first roller is non-parallel to the moving direction and the stacking direction, and the second transmission belt connects the first roller and the pushing assemblies and is spaced apart from the first transmission belt along the axial direction of the first roller.

8. The battery box according to claim 7, wherein the at least one transmission assembly further comprises a second roller, the second roller is rotatably disposed on the housing and is spaced apart from the first roller, the second transmission belt comprises a first fixed portion, a second fixed portion and a wound portion, the wound portion connects the first fixed portion and the second fixed portion, the first fixed portion and the second fixed portion are connected to the first roller and the pushing assembly, respectively, and the wound portion is wound on the second roller.

9. The battery box according to claim 8, wherein the second transmission belt further comprises a pre-wound portion, and the pre-wound portion is connected to an end of the first fixed portion that is located farthest away from the wound portion and is wound on the first roller.

10. The battery box according to claim 8, further comprising a connecting plate, wherein the connecting plate is configured to rest on one side of the pushing assembly that is located farthest away from the battery pack, and the second fixed portion is fixed to the connecting plate.

11. The battery box according to claim 10, wherein the at least one cylinder comprises two cylinders and the at least one transmission assembly comprises two transmission assemblies, the movable rods of the two cylinders are connected to the two transmission assemblies, respectively, and the second fixed portions of the second transmission belts of the two transmission assemblies are fixed to two opposite sides of the connecting plates, respectively.

12. The battery box according to claim 11, wherein the two cylinders are misaligned with each other.

13. The battery box according to claim 8, wherein the pushing assembly comprises a pushing plate and a pushed plate, the pushing plate is configured to be stacked on one side of the battery pack, the pushed plate is configured to rest on one side of the pushing plate that is located farthest away from the battery pack, the pushed plate has a fixing protrusion, and the second fixed portion is fixed to the fixing protrusion.

14. The battery box according to claim 6, wherein the at least one cylinder is a pneumatic cylinder.

15. The battery box according to claim 14, wherein the cylinder body of the at least one cylinder is in fluid communication with an external container via a tube.

16. The battery box according to claim 6, wherein the moving direction is perpendicular to the stacking direction.
